(19) United States
(12) Patent Application Publication
(10) Pub. No.: US 2024/0095683 A1
(43) Pub. Date: Mar. 21, 2024

(54) COMPONENT REPLACEMENT FRAMEWORK

(71) Applicant: Dell Products L.P., Round Rock, TX (US)

(72) Inventors: David J. Linsey, Marietta, GA (US); Kulin Shaival Chokshi, Round Rock, TX (US); Shijin Babu, Round Rock, TX (US)

(21) Appl. No.: 17/946,212

(22) Filed: Sep. 16, 2022

(51) Int. Cl. G06Q 10/00; G06Q 10/08

(52) U.S. Cl. CPC G06Q 10/20; G06Q 10/083; G06Q 30/016

(57) ABSTRACT

A method comprises collecting operational data corresponding to one or more components of at least one device and analyzing the operational data against one or more thresholds for component replacement. In the method, one or more alerts for at least one user are generated responsive to meeting the one or more thresholds. One or more communications are received from the at least one user in response to the one or more alerts. One or more replacement components for the one or more components are dispatched to the at least one user based at least in part on the received one or more communications. In analyzing the operational data, one or more databases are accessed to identify a support entitlement of the at least one user for the at least one device, and at least one threshold of the one or more thresholds corresponding to the identified support entitlement is identified.

### FIELD

The field relates generally to information processing systems, and more particularly to component replacement in information processing systems.

### BACKGROUND

Technology products and their components may degrade over time, in some cases, to the point of failure. Such degradation and/or failures can result in unwanted device downtime and/or reduced performance of the technology products. Current approaches for maintaining device performance and operation are limited to addressing issues after the occurrence of a problem. The reactive nature of current approaches is not suitable for modern applications and expectations requiring continuous device operation.

### SUMMARY

Embodiments provide a component replacement platform in an information processing system.

For example, in one embodiment, a method comprises collecting operational data corresponding to one or more components of at least one device and analyzing the operational data against one or more thresholds for component replacement. In the method, one or more alerts for at least one user are generated responsive to meeting the one or more thresholds. One or more communications are received from the at least one user in response to the one or more alerts. One or more replacement components for the one or more components are dispatched to the at least one user based at least in part on the received one or more communications. In analyzing the operational data against the one or more thresholds, one or more databases are accessed to identify a support entitlement of the at least one user for the at least one device, and at least one threshold of the one or more thresholds corresponding to the identified support entitlement is identified.

Further illustrative embodiments are provided in the form of a non-transitory computer-readable storage medium having embodied therein executable program code that when executed by a processor causes the processor to perform the above steps. Still further illustrative embodiments comprise an apparatus with a processor and a memory configured to perform the above steps.

These and other features and advantages of embodiments described herein will become more apparent from the accompanying drawings and the following detailed description.

### BRIEF DESCRIPTION OF THE DRAWINGS

FIG. 1 depicts an information processing system with a component replacement platform in an illustrative embodiment.

FIG. 2 depicts an operational flow for transmission of user device operational data to an operational data repository in an illustrative embodiment.

FIG. 3 depicts a table illustrating evaluation of example lifespan metrics and corresponding support plan thresholds in an illustrative embodiment.

FIG. 4 depicts an operational flow for application of rules to lifespan metrics and operational data in an illustrative embodiment.

FIG. 5 depicts an operational flow for executing component replacement in an illustrative embodiment.

FIG. 6 depicts a table illustrating example lifespan metric values for a first device over a particular time period in an illustrative embodiment.

FIG. 7 depicts a table illustrating example lifespan metric values for a second device over the particular time period in an illustrative embodiment.

FIG. 8 depicts a process for component replacement according to an illustrative embodiment.

FIGS. 9 and 10 show examples of processing platforms that may be utilized to implement at least a portion of an information processing system according to illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Such systems are considered examples of what are more generally referred to herein as cloud-based computing environments. Some cloud infrastructures are within the exclusive control and management of a given enterprise, and therefore are considered “private clouds.” The term “enterprise” as used herein is intended to be broadly construed, and may comprise, for example, one or more businesses, one or more corporations or any other one or more entities, groups, or organizations. An “entity” as illustratively used herein may be a person or system. On the other hand, cloud infrastructures that are used by multiple enterprises, and not necessarily controlled or managed by any of the multiple enterprises but rather respectively controlled and managed by third-party cloud providers, are typically considered “public clouds.” Enterprises can choose to host their applications or services on private clouds, public clouds, and/or a combination of private and public clouds (hybrid clouds) with a vast array of computing resources attached to or otherwise a part of the infrastructure. Numerous other types of enterprise computing and storage systems are also encompassed by the term “information processing system” as that term is broadly used herein.

As used herein, “real-time” refers to output within strict time constraints. Real-time output can be understood to be instantaneous or on the order of milliseconds or microseconds. Real-time output can occur when the connections with a network are continuous and a user device receives messages without any significant time delay. Of course, it should be understood that depending on the particular temporal nature of the system in which an embodiment is implemented, other appropriate timescales that provide at least contemporaneous performance and output can be achieved.

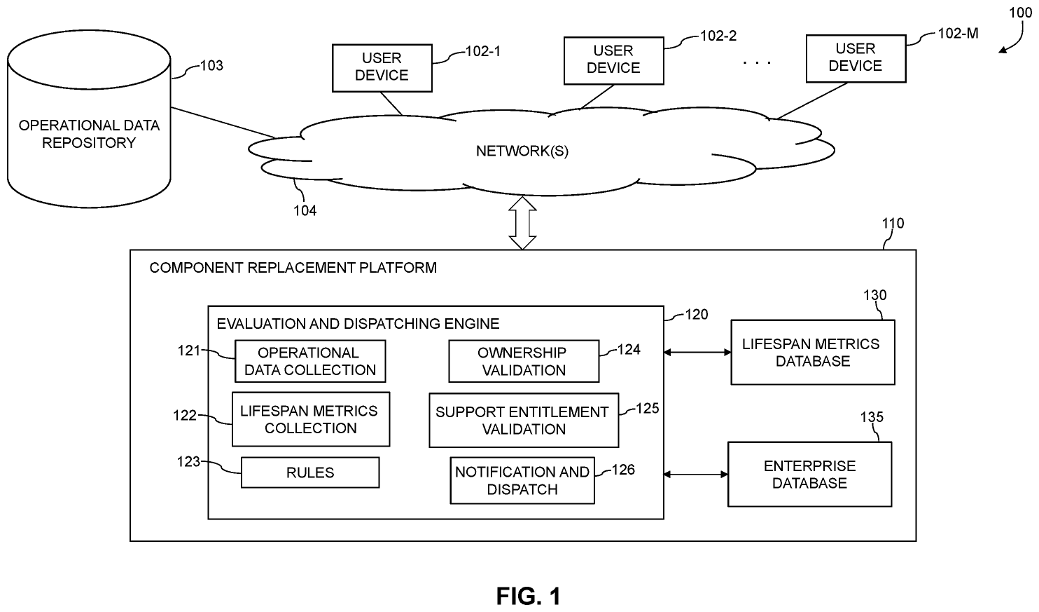

FIG. 1 shows an information processing system 100 configured in accordance with an illustrative embodiment. The information processing system 100 comprises user devices 102-1, 102-2, . . . 102-M (collectively “user devices 102”) and at least one operational data repository 103. The user devices 102 and operational data repository 103 communicate over a network 104 with a component replacement platform 110. The variable M and other similar index variables herein such as K, L, N and S are assumed to be arbitrary positive integers greater than or equal to one.

The user devices 102 can comprise, for example, Internet of Things (IoT) devices, desktop, laptop or tablet computers, mobile telephones, networking devices, storage arrays and devices, servers, peripheral devices or other types of processing devices capable of communicating with the component replacement platform 110 over the network 104. Such devices are examples of what are more generally referred to herein as “processing devices.” Some of these processing devices are also generally referred to herein as “computers.” The user devices 102 may also or alternately comprise virtualized computing resources, such as virtual machines (VMs), containers, etc. The user devices 102 in some embodiments comprise respective computers associated with a particular company, organization or other enterprise.

The terms “customer,” “administrator,” “personnel” or “user” herein are intended to be broadly construed so as to encompass numerous arrangements of human, hardware, software or firmware entities, as well as combinations of such entities. Component replacement services may be provided for users utilizing one or more machine learning models, although it is to be appreciated that other types of infrastructure arrangements could be used. At least a portion of the available services and functionalities provided by the component replacement platform 110 in some embodiments may be provided under Function-as-a-Service (“FaaS”), Containers-as-a-Service (“CaaS”) and/or Platform-as-a-Service (“PaaS”) models, including cloud-based FaaS, CaaS and PaaS environments.

Although not explicitly shown in FIG. 1, one or more input-output devices such as keyboards, displays or other types of input-output devices may be used to support one or more user interfaces to the component replacement platform 110, as well as to support communication between the component replacement platform 110 and connected devices (e.g., user devices 102) and/or other related systems and devices not explicitly shown.

In some embodiments, the user devices 102 are assumed to be associated with repair technicians, system administrators, information technology (IT) managers, software developers, release management personnel or other authorized personnel configured to access and utilize the component replacement platform 110.

In illustrative embodiments, the user devices 102 are respectively associated with one or more customers or other users. The user devices 102 may be, for example, enterprise-grade or consumer-grade products from which continuous operation may be expected. Illustrative embodiments provide techniques to automatically replace one or more components of the user devices 102 prior to failure of the one or more components. In more detail, within technology products such as, for example, compute, storage and networking devices (e.g., user devices 102), some components may have a particular serviceable lifespan. For example, components including, but not necessarily limited to, batteries, fans and power supplies may degrade over time, eventually to the point of failure. These failures can result in unwanted downtime or degradation of the corresponding technology product. In an effort to avoid such failures, illustrative embodiments provide technical solutions that identify components within a product which are susceptible to degradation and ultimate failure. Based on the identification, the embodiments advantageously provide techniques for automated validation of product ownership and eligibility for replacement components, and automated delivery of replacement components in advance of product failure.

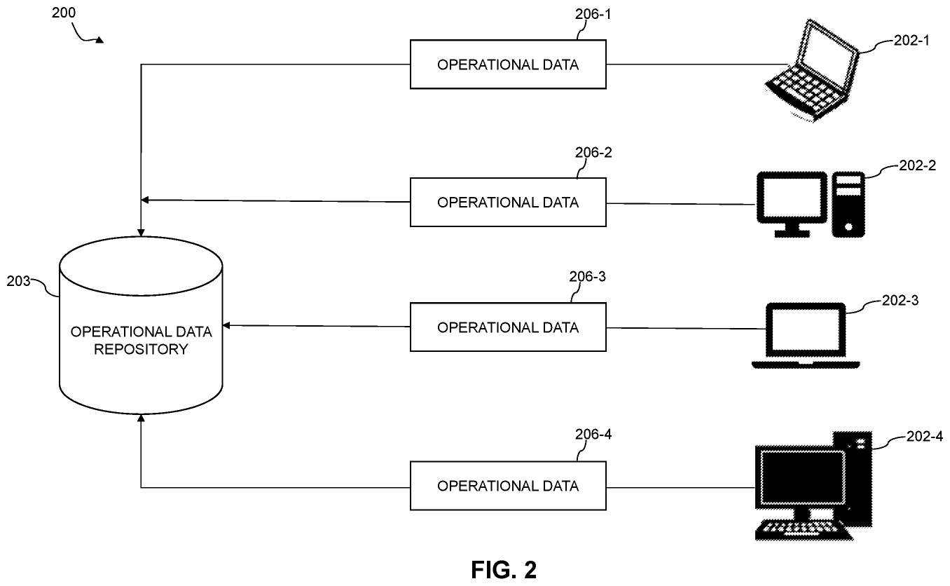

In accordance with illustrative embodiments, during operation of the user devices 102, the user devices 102 and/or the components thereof record and transmit operational data (also referred to herein as “telemetry data”) for the device components to at least one operational data repository 103, which stores the received operational data. In some instances, an operational data repository may be part of the user device 102 (e.g., a storage repository on the user device 102) or as a separate storage repository (e.g., operational data repository 103) as shown in FIG. 1, which is accessible by the user devices 102 and the component replacement platform 110 over network 104. The operational data repository 103 may be, for example, cloud-based or local to a particular enterprise. Referring to the operational flow 200 in FIG. 2, operational data 206-1, 206-2, 206-3 and 206-4 (collectively “operational data 206”) from user devices 202-1, 202-2, 202-3 and 202-4, respectively (collectively “user devices 202”), is transmitted to operational data repository 203. The user devices 202 are the same as or similar to the user devices 102 in FIG. 1, and the operational data repository 203 is the same as or similar to the operational data repository 103 in FIG. 1. The operational data 206 may be transmitted to the operational data repository 203 over one or more networks such as, for example, network 104. The operational data 206 comprises, for example, universally unique identifiers (UUIDs) or other identifiers of device components, operating system type and/or version and/or current software and/or firmware types and/or versions used by the user devices 202. The operational data further comprises performance metrics such as, but not necessarily limited to, throughput, latency, memory capacity and usage, response and completion time, communication failures, temperature, component revolutions per minute (RPMs) (e.g., fan RPMs), battery or other power supply capacity (e.g., usable capacity percentage), channel capacity and bandwidth or other types of data which may be collected via, for example, sensors or other equipment or software associated with a user device 102.

The component replacement platform 110 in the present embodiment is assumed to be accessible to the user devices 102 and/or operational data repository 103 and vice versa over the network 104. The network 104 is assumed to comprise a portion of a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks. The network 104 in some embodiments therefore comprises combinations of multiple different types of networks each comprising processing devices configured to communicate using Internet Protocol (IP) or other related communication protocols.

As a more particular example, some embodiments may utilize one or more high-speed local networks in which associated processing devices communicate with one another utilizing Peripheral Component Interconnect express (PCIe) cards of those devices, and networking protocols such as InfiniBand, Gigabit Ethernet or Fibre Channel. Numerous alternative networking arrangements are possible in a given embodiment, as will be appreciated by those skilled in the art.

Referring to FIG. 1, the component replacement platform 110 includes an evaluation and dispatching engine 120, a lifespan metrics database 130 and an enterprise database 135. The evaluation and dispatching engine 120 includes an operational data collection layer 121, a lifespan metrics collection layer 122, a rules layer 123, an ownership validation layer 124, a support entitlement validation layer 125 and a notification and dispatch layer 126.

The operational data collection layer 121 of the evaluation and dispatching engine 120 collects operational data of the user devices 102 and the corresponding components of the user devices 102 from the operational data repository 103. The collected operational data can be transmitted from the operational data repository 103 to the evaluation and dispatching engine 120 in one or more data streams over network 104. The collection of operational data from the operational data repository 103 may be performed at designated intervals (e.g., periodic intervals). In some embodiments, the operational data is pulled from the operational data repository 103 by the operational data collection layer 121 at designated intervals. Alternatively, the operational data repository 103 pushes the operational data to the operational data collection layer 121 at designated intervals. In some cases, the operational data collection layer 121 removes unwanted characters, punctuation, and stop words from the operational data.

The lifespan metrics collection layer 122 collects lifespan metrics data from the lifespan metrics database 130. For example, the serviceable lifespan of device components are associated with different metrics such as, for example, usable capacity and RPM. The lifespan metrics database 130 includes mappings of different components to their corresponding metrics. For example, a battery or other power source is mapped to a usable capacity metric, and moving parts such as, for example, fans and hard disks are mapped to an RPM metric. Metrics for particular components may be modified in or input to the lifespan metrics database 130 and transmitted to the lifespan metrics collection layer 122. The lifespan metrics are established according to trends associated with indicators for when components degrade or lose their effectiveness. According to one or more embodiments, such trends are automatically identified using one or more machine learning models to predict which metrics indicate component degradation. The machine learning models may predict the metrics based on training data specifying identified metrics in connection with historical instances of component degradation. In other embodiments, the metrics may be specified by a technical expert.

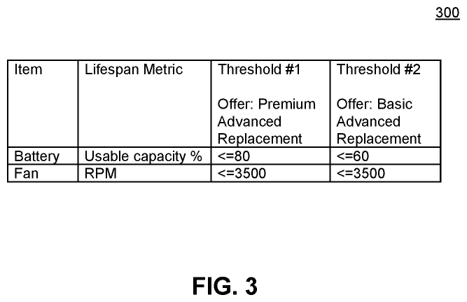

The rules layer 123 includes rules to be applied to the lifespan metrics to determine whether a component of a user device 102 should be replaced. The rules associate lifespan metrics of device components with one or more thresholds to determine serviceable lifespan of device components and whether the components should be replaced. In illustrative embodiments, the rules are further based on a support entitlement level of an owner of a given device. For example, an owner of a higher value service plan may be entitled to a replacement component before an owner of a lower value service plan. In other words, in order to be eligible for replacement, a component may need to exhibit poorer performance under a lower value service plan than under a higher value service plan. For example, referring to the table 300 in FIG. 3, the lifespan metrics for a battery and a fan are usable capacity (%) and RPM. According to a first rule, under a premium advanced replacement support plan, if battery capacity is less than or equal to 80%, the battery is eligible for replacement. According to a second rule, under a basic advanced replacement support plan, if battery capacity is less than or equal to 60%, the battery is eligible for replacement. As can be understood, less degradation of the battery is required for replacement under the premium advanced replacement support plan than under the basic advanced replacement support plan. The embodiments, therefore, automatically factor support plan entitlement into whether a replacement component is recommended. In some cases, the level of support entitlement may not be a factor for whether a replacement component is recommended. For example, referring to table 300, in the case of a fan, the threshold for replacement (less than or equal to 3500 RPM) is same under both premium and basic advanced replacement support plans.

In illustrative embodiments, the evaluation and dispatching engine 120 continuously evaluates incoming operational data (e.g., operational data 206) of the user devices 102/202 from the operational data repository 103/203 against the defined lifespan metrics and associated thresholds until a threshold is met. As noted herein, the incoming operational data may be sent to the operational data repository 103/203 and collected by the operational data collection layer 121 at designated intervals. In a non-limiting operational example, based on the defined lifespan metrics and thresholds in table 300, when a battery in a user device 102/202 reaches less than or equal to 80 percent usable capacity, the rule for threshold #1 is triggered, and if the serviceable lifespan of the battery continues to degrade down to less than or equal to 60 percent usable capacity, the rule for threshold #2 is triggered.

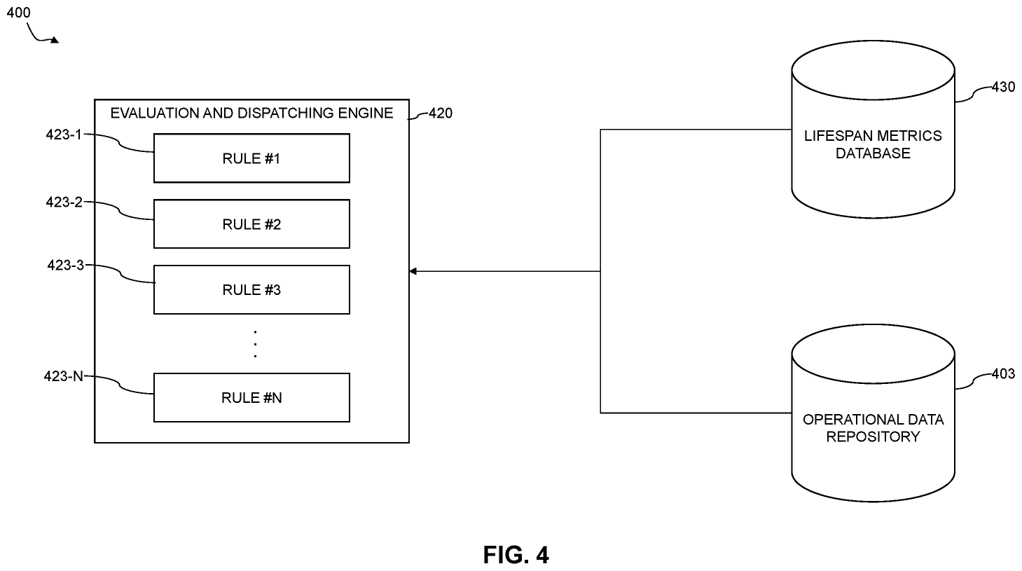

Referring to FIG. 4, an operational flow 400 depicts the application of one or more rules (e.g., Rule #1 423-1, Rule #2 423-2, Rule #3 423-3, . . . , Rule #N 423-N (collectively “Rules 423”)) by an evaluation and dispatching engine 420 to lifespan metrics from a lifespan metrics database 430 and to operational data from an operational data repository 403. The evaluation and dispatching engine 420 is the same as or similar to the evaluation and dispatching engine 120 in FIG. 1, the operational data repository 403 is the same as or similar to the operational data repository 103 in FIG. 1 and the lifespan metrics database 430 is the same as or similar to the lifespan metrics database 130 in FIG. 1. The evaluation and dispatching engine 420 includes a plurality of Rules 423 which can be applied by a rules layer to operational data. As explained herein, the Rules 423 may include thresholds specifying limits for different lifespan metrics (e.g., minimum battery capacity, minimum number of component RPMs, etc.) to trigger component replacement. In addition, the thresholds can vary based at least in part on a corresponding product support entitlement associated with a device in which the component is located. According to one or more embodiments, the rules including the thresholds are automatically generated using one or more machine learning models based on training data specifying circumstances (e.g., lifespan metric values) leading to historical component failure. For example, supervised learning can be performed with labeled training data indicating lifespan metric values at which failure of corresponding components occurred. In other embodiments, the rules may be specified by a technical expert.

According to illustrative embodiments, the operational data is sent to and/or retrieved by the operational data repository 403 from the user devices (e.g., user devices 102) at designated intervals. The operational data is sent to and/or retrieved by the operational data collection layer 121 from operational data repository 403 at designated intervals and is continuously evaluated by a rules layer (e.g., rules layer 123), which applies the Rules 423 to the operational data to determine whether components of user devices should be recommended for replacement.

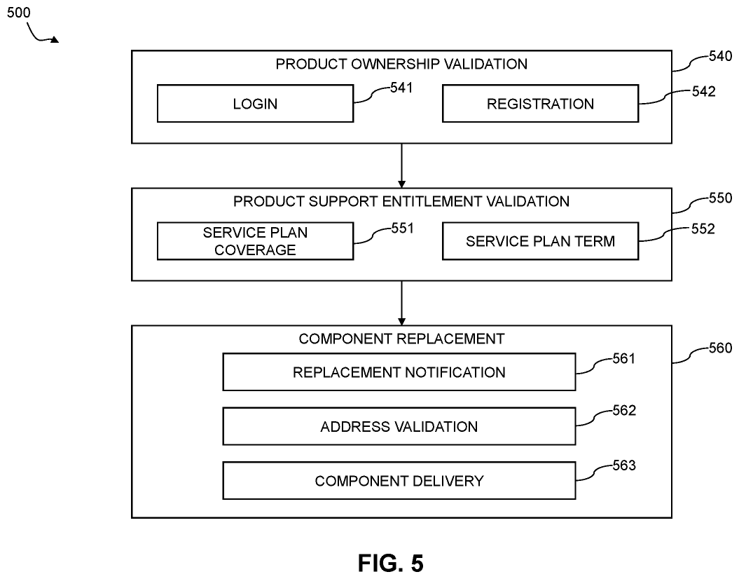

Referring to FIG. 1 and to the operational flow 500 in FIG. 5, responsive to a component of a device triggering a threshold for a lifespan metric (e.g., battery capacity≤a particular value, RPM≤a particular value, etc.), the ownership validation layer 124 of the evaluation and dispatching engine 120 authenticates ownership of the device. For example, referring to the product ownership validation block 540 in FIG. 5, the ownership validation layer 124 generates one or more alerts to be sent to an owner of record for the device. The alerts comprise, for example, a pop-up window and/or an email requesting ownership verification of the device. The pop-up window can be generated on the user device from which the operational data meeting the threshold was received. Device identifiers such as, for example, UUIDs and IP addresses may be part of the received operational data and used by the ownership validation layer 124 to send the pop-up alert to the corresponding device over one or more networks (e.g., network 104). In the case of an email, owners of record and their email contact details may be retrieved from, for example, an enterprise database 135, and used to send an email over the one or more networks. Other means of communicating with the owners may be used including, for example, short message service (SMS) via mobile phones. Referring to blocks 541 and 542, in illustrative embodiments, the alert includes prompts for a user to login to or register with an enterprise system to validate ownership. The login process may require a user to input previously established login credentials and the registration process may require a user to input user information known to and which can be verified by the enterprise. Such login credentials and user information may be stored in the enterprise database 135 and confirmed by the ownership validation layer 124.

Also, in response to a component of a device triggering a threshold for a lifespan metric, the support entitlement validation layer 125 of the evaluation and dispatching engine 120 validates a level of support entitlement and whether a support plan is active in connection with a user device from which the operational data meeting the threshold was received. For example, referring to the product support entitlement validation block 550 in FIG. 5 and, more particularly to the service plan coverage and service plan term blocks 551 and 552, the support entitlement validation layer 125 mines the enterprise database 135 to identify active service plans and their scope for a corresponding device. For example, in connection with the operational example described herein, thresholds to trigger component replacement can vary based on an identified product support entitlement (e.g., a basic service plan requiring more component degradation than a premium service plan). In some instances, when a threshold is not tied to a level of support, support entitlement validation may be omitted.

Once ownership and support entitlement are validated, the notification and dispatch layer 126 of the evaluation and dispatching engine 120 generates one or more alerts to be sent to users informing the users that there is a component requiring replacement and requesting address validation. For example, referring to the replacement notification block 561 of the component replacement block 560 in FIG. 5, the one or more alerts are sent to the verified owner and comprise, for example, a pop-up window and/or an email indicating that one or more components of a device require replacement. In addition, referring to the address validation block 562, the one or more alerts further comprise, for example, a pop-up window and/or an email requesting owner address verification. In some cases, a user may be traveling with an affected device and may be located at a temporary address that may be verified and used for delivery of a replacement component.

Similar to ownership verification alerts, pop-up windows can be generated on the user device from which the operational data meeting the threshold was received. Device identifiers such as, for example, UUIDs and IP addresses may be part of the received operational data and used by the notification and dispatch layer 126 to send pop-up alerts to the corresponding device over one or more networks (e.g., network 104). In the case of an email, verified owners and their verified email contact details are used to send an email over the one or more networks. Other means of communicating with the owners may be used including, for example, SMS.

Referring to the component delivery block 563 in FIG. 5, the notification and dispatch layer 126 automatically dispatches one or more replacement components to a verified address. In illustrative embodiments, the notification and dispatch layer 126 further generates one or more alerts (e.g., pop-windows and/or emails) requesting that a user specify a delivery period convenient for the user to deliver the one or more replacement components. In some instances, the alert may include estimated delivery windows from a logistics provider from which a user may choose a delivery period. The notification and dispatch layer 126 automatically dispatches the one or more replacement components for delivery during a delivery period selected by a user.

In some embodiments, the notification and dispatch layer 126 further generates one or more alerts (e.g., pop-windows and/or emails) indicating that a user has an option to install the replacement component on the corresponding device or have a service provider install the replacement component. In the case of choosing that a service provider install the replacement component, the notification and dispatch layer 126 further generates one or more alerts requesting that the user specify an installation time convenient for the user to have a service provider install the one or more replacement components. In some instances, the alert may include estimated installation windows from a logistics provider from which a user may choose an installation period. The notification and dispatch layer 126 automatically dispatches a service provider to install the one or more replacement components during an installation period selected by a user. As can be understood, communications from a user in response to the one or more alerts may be provided via one or more user interfaces and/or online portals on user devices 102 and transmitted over one or more networks (e.g., network 104).

As used herein, the phrase “automatically dispatch” or “automatic dispatch” is to be broadly construed to refer to, for example, automated initiation and/or execution of required steps for delivery of replacement components to and/or installation of replacement components for users. Such required steps may include, but are not necessarily limited to, automated identification and ordering of replacement components from internal or external inventory sources, automated packaging and/or labeling of packages for replacement components (e.g., with verified addresses) for delivery, automated shipping of replacement components, automated generation of messages to be sent to enterprise personnel including instructions to prepare replacement components for delivery and to deliver replacement components, automated selection of service personnel to install replacement components, automated generation of work orders for service personnel to install replacement components and/or automated generation of messages to be sent to service personnel including installation work orders for replacement components.

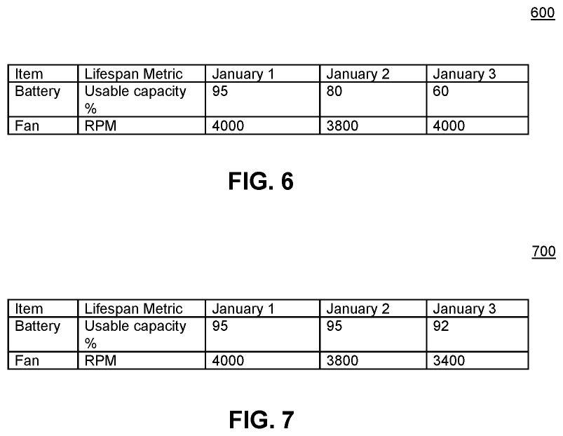

In a non-limiting illustrative example, a customer (e.g., user of one of the user devices 102) is assumed to have purchased a basic service plan subject to Threshold #2 in the table 300 in FIG. 3. Referring to the table 600 in FIG. 6 illustrating example lifespan metric values for a first device over a particular time period, on January 1 there is no triggering of Threshold #1 or Threshold #2 since battery capacity is ≥80% and fan RPM is ≥3500. Accordingly, no action is taken by the evaluation and dispatching engine 120 to notify the customer and/or initiate a replacement component process on January 1, but the evaluation and dispatching engine 120 continues to monitor the operational data for the battery and the fan. On January 2, while Threshold #1 (≤80% battery capacity) is reached for a battery, this threshold is only for the Premium Advanced Replacement offer and the customer is assumed to have purchased a basic service plan. Accordingly, no action is taken by the evaluation and dispatching engine 120 to notify the customer and/or initiate a replacement component process on January 2, but the evaluation and dispatching engine 120 continues to monitor the operational data for the battery and the fan. On January 3, the battery usable capacity percentage continued to degrade and reached threshold #2 of ≤60% for the Basic Advanced Replacement offer. Accordingly, the evaluation and dispatching engine 120 notifies the customer and initiates a replacement component process on January 3 for the battery. For example, in an illustrative embodiment, the ownership validation layer 124 directs the customer to confirm their identity using an online portal (e.g., login and registration blocks 541 and 542 of FIG. 5). The support entitlement validation layer 125 will also confirm whether the appropriate service plan is valid and tied to the right owner. After this validation, the notification and dispatch layer 126 generates a message asking the customer to confirm their shipping address against an address in the enterprise database 135. The customer will also be given an opportunity to select via, for example, a user interface on one of the user devices 102, a preferable window of time for shipping and delivery of the replacement component. Responsive to these validations, the notification and dispatch layer 126 dispatches a replacement battery proactively before the battery fails on the first device.

Since the fan RPM for the first device does not meet Thresholds #1 or #2 during the noted time periods, no action is taken by the evaluation and dispatching engine 120 to notify the customer and/or initiate a replacement process for the fan, but the evaluation and dispatching engine 120 continues to monitor the operational data for the fan of the first device.

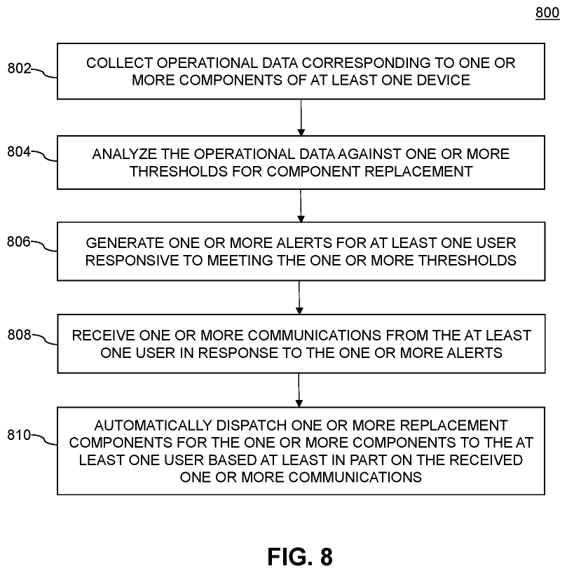

In another non-limiting illustrative example, a customer (e.g., user of one of the user devices 102) is assumed to have purchased a premium service plan subject to Threshold #1 in the table 300 in FIG. 3. Referring to the table 700 in FIG. 7 illustrating example lifespan metric values for a second device over a particular time period, on January 1 and January 2 there is no triggering of Threshold #1 or Threshold #2 since battery capacity is ≥80% and fan RPM is ≥3500. Accordingly, no action is taken by the evaluation and dispatching engine 120 to notify the customer and/or initiate a replacement component process on January 1 or January 2, but the evaluation and dispatching engine 120 continues to monitor the operational data for the battery and the fan. On January 3, the fan RPM continued to degrade and reached threshold #1 of ≤3500 for the Premium Advanced Replacement offer. Accordingly, the evaluation and dispatching engine 120 notifies the customer and initiates a replacement component process on January 3 for the fan. For example, in an illustrative embodiment, the ownership validation layer 124 directs the customer to confirm their identity using an online portal (e.g., login and registration blocks 541 and 542 of FIG. 5). The support entitlement validation layer 125 will also confirm whether the appropriate service plan is valid and tied to the right owner. After this validation, the notification and dispatch layer 126 generates a message asking the customer to confirm their shipping address against an address in the enterprise database 135. The customer will also be given an opportunity to select via, for example, a user interface on one of the user devices 102, a preferable window of time for shipping and delivery of the replacement component. Responsive to these validations, the notification and dispatch layer 126 dispatches a replacement fan proactively before the fan fails on the second device. It is to be understood that the fan RPM value is the same for Thresholds #1 and #2 in this example, but the embodiments are not necessarily limited thereto.

Since the battery capacity for the first device does not meet Thresholds #1 or #2 during the noted time periods, no action is taken by the evaluation and dispatching engine 120 to notify the customer and/or initiate a replacement process for the fan, but the evaluation and dispatching engine 120 continues to monitor the operational data for the fan of the second device.

According to one or more embodiments, the operational data repositories 103, 203 and 403, the lifespan metrics databases 130 and 430, the enterprise database 135 and other repositories or databases referred to herein can be configured according to a relational database management system (RDBMS) (e.g., PostgreSQL). In some embodiments, the operational data repositories 103, 203 and 403, the lifespan metrics databases 130 and 430, the enterprise database 135 and other repositories or databases referred to herein are implemented using one or more storage systems or devices associated with the component replacement platform 110. In some embodiments, one or more of the storage systems utilized to implement the operational data repositories 103, 203 and 403, the lifespan metrics databases 130 and 430, the enterprise database 135 and other repositories or databases referred to herein comprise a scale-out all-flash content addressable storage array or other type of storage array.

The term “storage system” as used herein is therefore intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although shown as elements of the component replacement platform 110, the evaluation and dispatching engine 120, the lifespan metrics database 130 and/or the enterprise database 135 in other embodiments can be implemented at least in part externally to the component replacement platform 110, for example, as stand-alone servers, sets of servers or other types of systems coupled to the network 104. For example, the evaluation and dispatching engine 120, the lifespan metrics database 130 and/or the enterprise database 135 may be provided as cloud services accessible by the component replacement platform 110.

The evaluation and dispatching engine 120, the lifespan metrics database 130 and/or the enterprise database 135 in the FIG. 1 embodiment are each assumed to be implemented using at least one processing device. Each such processing device generally comprises at least one processor and an associated memory, and implements one or more functional modules for controlling certain features of the evaluation and dispatching engine 120, the lifespan metrics database 130 and/or the enterprise database 135.

At least portions of the component replacement platform 110 and the elements thereof may be implemented at least in part in the form of software that is stored in memory and executed by a processor. The component replacement platform 110 and the elements thereof comprise further hardware and software required for running the component replacement platform 110, including, but not necessarily limited to, on-premises or cloud-based centralized hardware, graphics processing unit (GPU) hardware, virtualization infrastructure software and hardware, Docker containers, networking software and hardware, and cloud infrastructure software and hardware.

Although the evaluation and dispatching engine 120, the lifespan metrics database 130, the enterprise database 135 and other elements of the component replacement platform 110 in the present embodiment are shown as part of the component replacement platform 110, at least a portion of the evaluation and dispatching engine 120, the lifespan metrics database 130, the enterprise database 135 and other elements of the component replacement platform 110 in other embodiments may be implemented on one or more other processing platforms that are accessible to the component replacement platform 110 over one or more networks. Such elements can each be implemented at least in part within another system element or at least in part utilizing one or more stand-alone elements coupled to the network 104.

It is assumed that the component replacement platform 110 in the FIG. 1 embodiment and other processing platforms referred to herein are each implemented using a plurality of processing devices each having a processor coupled to a memory. Such processing devices can illustratively include particular arrangements of compute, storage and network resources. For example, processing devices in some embodiments are implemented at least in part utilizing virtual resources such as virtual machines (VMs) or (Linux containers) LXCs, or combinations of both as in an arrangement in which Docker containers or other types of LXCs are configured to run on VMs.

The term “processing platform” as used herein is intended to be broadly construed so as to encompass, by way of illustration and without limitation, multiple sets of processing devices and one or more associated storage systems that are configured to communicate over one or more networks.

As a more particular example, the evaluation and dispatching engine 120, the lifespan metrics database 130, the enterprise database 135 and other elements of the component replacement platform 110, and the elements thereof can each be implemented in the form of one or more LXCs running on one or more VMs. Other arrangements of one or more processing devices of a processing platform can be used to implement the evaluation and dispatching engine 120, the lifespan metrics database 130 and the enterprise database 135, as well as other elements of the component replacement platform 110. Other portions of the system 100 can similarly be implemented using one or more processing devices of at least one processing platform.

Distributed implementations of the system 100 are possible, in which certain elements of the system reside in one data center in a first geographic location while other elements of the system reside in one or more other data centers in one or more other geographic locations that are potentially remote from the first geographic location. Thus, it is possible in some implementations of the system 100 for different portions of the component replacement platform 110 to reside in different data centers. Numerous other distributed implementations of the component replacement platform 110 are possible.

Accordingly, one or each of the evaluation and dispatching engine 120, the lifespan metrics database 130, the enterprise database 135 and other elements of the component replacement platform 110 can each be implemented in a distributed manner so as to comprise a plurality of distributed elements implemented on respective ones of a plurality of compute nodes of the component replacement platform 110.

It is to be appreciated that these and other features of illustrative embodiments are presented by way of example only, and should not be construed as limiting in any way. Accordingly, different numbers, types and arrangements of system elements such as the evaluation and dispatching engine 120, the lifespan metrics database 130, enterprise database 140 and other elements of the component replacement platform 110, and the portions thereof can be used in other embodiments.

It should be understood that the particular sets of modules and other elements implemented in the system 100 as illustrated in FIG. 1 are presented by way of example only. In other embodiments, only subsets of these elements, or additional or alternative sets of elements, may be used, and such elements may exhibit alternative functionality and configurations.

For example, as indicated previously, in some illustrative embodiments, functionality for the component replacement platform can be offered to cloud infrastructure customers or other users as part of FaaS, CaaS and/or PaaS offerings.

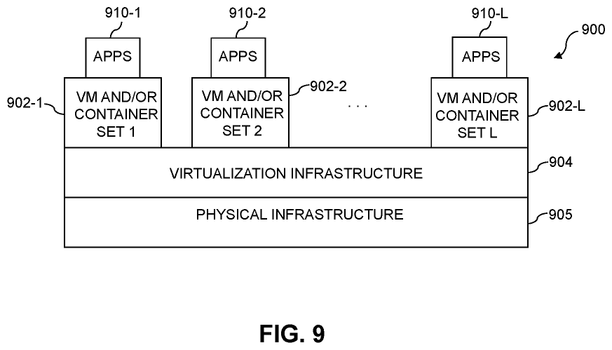

The operation of the information processing system 100 will now be described in further detail with reference to the flow diagram of FIG. 8. With reference to FIG. 8, a process 800 for component replacement as shown includes steps 802 through 810 and is suitable for use in the system 100 but is more generally applicable to other types of information processing systems comprising a component replacement platform configured for identifying components which are susceptible to degradation and ultimate failure, and for delivering replacement components in advance of component and/or product failure.

In step 802, operational data corresponding to one or more components of at least one device is collected. The operational data comprises, but is not necessarily limited to, battery capacity and/or component RPMs. In step 804, the operational data is analyzed against one or more thresholds for component replacement. The one or more thresholds comprise, but are not necessarily limited to, a minimum battery capacity and a minimum number of component RPMs. The one or more thresholds may vary based at least in part on a corresponding product support entitlement associated with the at least one device. In illustrative embodiments, one or more databases are mined to identify product support entitlement of the at least one user for the at least one device, wherein the one or more thresholds vary based at least in part on an identified product support entitlement. At least one threshold of the one or more thresholds corresponding to the identified support entitlement is identified, and is compared with the operational data to determine if the at least one threshold is met. According to one or more embodiments, the collecting and analyzing are continuously performed until the operational data meets the one or more thresholds.

In step 806, one or more alerts for at least one user are generated in response to meeting the one or more thresholds. The one or more alerts comprise, but are not necessarily limited to, a pop-up window and/or an email indicating that the one or more components require replacement, and/or requesting ownership verification of the at least one device. In step 808, one or more communications are received from the at least one user in response to the one or more alerts.

In step 810, one or more replacement components for the one or more components are automatically dispatched to the at least one user based at least in part on the received one or more communications. The one or more replacement components are automatically dispatched prior to failure of the one or more components.

In illustrative embodiments, the one or more alerts comprise, for example, a pop-up window and/or an email requesting address verification of the at least one user. The one or more replacement components are automatically dispatched to a verified address. The one or more alerts also comprise, for example, a pop-up window and/or an email requesting a delivery period to deliver the one or more replacement components to the at least one user. The one or more replacement components are automatically dispatched for delivery during the delivery period.

It is to be appreciated that the FIG. 8 process and other features and functionality described above can be adapted for use with other types of information systems configured to execute component replacement services in a component replacement platform or other type of platform.

The particular processing operations and other system functionality described in conjunction with the flow diagram of FIG. 8 are therefore presented by way of illustrative example only, and should not be construed as limiting the scope of the disclosure in any way. Alternative embodiments can use other types of processing operations. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another.

Functionality such as that described in conjunction with the flow diagram of FIG. 8 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Illustrative embodiments of systems with a component replacement platform as disclosed herein can provide a number of significant advantages relative to conventional arrangements. For example, the component replacement platform advantageously leverages operational data (e.g., telemetry data) from user devices to proactively identify device components that require replacement before device or component failures occur. Unlike conventional techniques, which are reactive to component or device failures that have already occurred, the embodiments use rules based on different device metrics and associated degradation thresholds to predict expected service life of device components, and proactively provide replacement components once thresholds are met.

As an additional advantage, upon identification of a component nearing an end of its serviceable lifespan, the intelligent replacement techniques of the illustrative embodiments proactively validate system support entitlements and device ownership via online interfaces. Additionally, the embodiments provide automated solutions which enable users to confirm their addresses and delivery preferences to permit advanced, convenient and proactive delivery of replacement components to users.

With conventional techniques, components of a system may fail at inopportune times causing unwanted device downtimes. While existing methodologies may result in these failed components appearing in a report or warning message, unlike the disclosed technical solutions, current approaches fail to predictively and proactively dispatch replacement components to customers prior to failure. In addition, unlike conventional approaches, the illustrative embodiments advantageously provide techniques for automated ownership and support plan validation.

As an additional advantage, the embodiments are well-suited to consumer products, especially mobile consumer products such as, but not necessarily limited to, notebook computers. The embodiments take into account that the mobile nature of certain products introduces difficulties in automatic dispatching of replacement components as the location and availability of users to receive support is unpredictable, dynamic and often not known by a manufacturer or service provider.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As noted above, at least portions of the information processing system 100 may be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform that may be used to implement at least a portion of an information processing system comprise cloud infrastructure including virtual machines and/or container sets implemented using a virtualization infrastructure that runs on a physical infrastructure. The cloud infrastructure further comprises sets of applications running on respective ones of the virtual machines and/or container sets.

These and other types of cloud infrastructure can be used to provide what is also referred to herein as a multi-tenant environment. One or more system elements such as the component replacement platform 110 or portions thereof are illustratively implemented for use by tenants of such a multi-tenant environment.

As mentioned previously, cloud infrastructure as disclosed herein can include cloud-based systems. Virtual machines provided in such systems can be used to implement at least portions of one or more of a computer system and a component replacement platform in illustrative embodiments. These and other cloud-based systems in illustrative embodiments can include object stores.

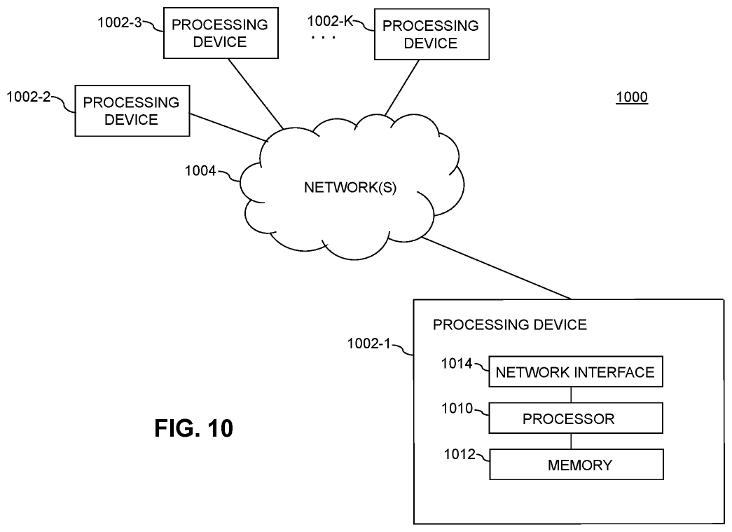

Illustrative embodiments of processing platforms will now be described in greater detail with reference to FIGS. 9 and 10. Although described in the context of system 100, these platforms may also be used to implement at least portions of other information processing systems in other embodiments.

FIG. 9 shows an example processing platform comprising cloud infrastructure 900. The cloud infrastructure 900 comprises a combination of physical and virtual processing resources that may be utilized to implement at least a portion of the information processing system 100. The cloud infrastructure 900 comprises multiple virtual machines (VMs) and/or container sets 902-1, 902-2, . . . 902-L implemented using virtualization infrastructure 904. The virtualization infrastructure 904 runs on physical infrastructure 905, and illustratively comprises one or more hypervisors and/or operating system level virtualization infrastructure. The operating system level virtualization infrastructure illustratively comprises kernel control groups of a Linux operating system or other type of operating system.

The cloud infrastructure 900 further comprises sets of applications 910-1, 910-2, . . . 910-L running on respective ones of the VMs/container sets 902-1, 902-2, . . . 902-L under the control of the virtualization infrastructure 904. The VMs/container sets 902 may comprise respective VMs, respective sets of one or more containers, or respective sets of one or more containers running in VMs.

In some implementations of the FIG. 9 embodiment, the VMs/container sets 902 comprise respective VMs implemented using virtualization infrastructure 904 that comprises at least one hypervisor. A hypervisor platform may be used to implement a hypervisor within the virtualization infrastructure 904, where the hypervisor platform has an associated virtual infrastructure management system. The underlying physical machines may comprise one or more distributed processing platforms that include one or more storage systems.

In other implementations of the FIG. 9 embodiment, the VMs/container sets 902 comprise respective containers implemented using virtualization infrastructure 904 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 900 shown in FIG. 9 may represent at least a portion of one processing platform. Another example of such a processing platform is processing platform 1000 shown in FIG. 10.

The processing platform 1000 in this embodiment comprises a portion of system 100 and includes a plurality of processing devices, denoted 1002-1, 1002-2, 1002-3, . . . 1002-K, which communicate with one another over a network 1004.

The network 1004 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1002-1 in the processing platform 1000 comprises a processor 1010 coupled to a memory 1012. The processor 1010 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 1012 may comprise random access memory (RAM), read-only memory (ROM), flash memory or other types of memory, in any combination. The memory 1012 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1002-1 is network interface circuitry 1014, which is used to interface the processing device with the network 1004 and other system components, and may comprise conventional transceivers.

The other processing devices 1002 of the processing platform 1000 are assumed to be configured in a manner similar to that shown for processing device 1002-1 in the figure.

Again, the particular processing platform 1000 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality of one or more elements of the component replacement platform 110 as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems and component replacement platforms. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
collecting operational data corresponding to one or more components of at least one device;
analyzing the operational data against one or more thresholds for component replacement;
generating one or more alerts for at least one user responsive to meeting the one or more thresholds;
receiving one or more communications from the at least one user in response to the one or more alerts; and
automatically dispatching one or more replacement components for the one or more components to the at least one user based at least in part on the received one or more communications;
wherein analyzing the operational data against the one or more thresholds comprises:
accessing one or more databases to identify a support entitlement of the at least one user for the at least one device; and
identifying at least one threshold of the one or more thresholds corresponding to the identified support entitlement;
wherein the steps of the method are executed by a processing device operatively coupled to a memory.

2. The method of claim 1 wherein the operational data comprises at least one of battery capacity and component revolutions per minute.

3. The method of claim 1 wherein the one or more thresholds comprise at least one of a minimum battery capacity and a minimum number of component revolutions per minute.

4. The method of claim 1 further comprising determining the one or more thresholds using one or more machine learning models.

5. The method of claim 4 further comprising training the one or more machine learning models with training data specifying operational data values at which component failure occurred.

6. The method of claim 1 wherein the one or more replacement components are automatically dispatched prior to failure of the one or more components.

7. The method of claim 1 wherein the one or more alerts comprise at least one of a pop-up window and an email indicating that the one or more components require replacement.

8. The method of claim 1 wherein the one or more alerts comprise at least one of a pop-up window and an email requesting ownership verification of the at least one device.

9. The method of claim 1 wherein the one or more alerts comprise at least one of a pop-up window and an email requesting address verification of the at least one user.

10. The method of claim 9 further comprising automatically dispatching the one or more replacement components to a verified address.

11. The method of claim 1 wherein the one or more alerts comprise at least one of a pop-up window and an email requesting a delivery period to deliver the one or more replacement components to the at least one user.

12. The method of claim 11 further comprising automatically dispatching the one or more replacement components for delivery during the delivery period.

13. The method of claim 1 wherein the collecting and analyzing are continuously performed until the operational data meets the one or more thresholds.

14. An apparatus comprising:
a processing device operatively coupled to a memory and configured:
to collect operational data corresponding to one or more components of at least one device;
to analyze the operational data against one or more thresholds for component replacement;
to generate one or more alerts for at least one user responsive to meeting the one or more thresholds;
to receive one or more communications from the at least one user in response to the one or more alerts; and
to automatically dispatch one or more replacement components for the one or more components to the at least one user based at least in part on the received one or more communications;
wherein, in analyzing the operational data against the one or more thresholds, the processing device is further configured:
to access one or more databases to identify a support entitlement of the at least one user for the at least one device; and
to identify at least one threshold of the one or more thresholds corresponding to the identified support entitlement.

15. The apparatus of claim 14 wherein the one or more alerts comprise at least one of a pop-up window and an email requesting address verification of the at least one user.

16. The apparatus of claim 15 wherein the processing device is further configured to automatically dispatch the one or more replacement components to a verified address.

17. The apparatus of claim 14 wherein the processing device is further configured to determine the one or more thresholds using one or more machine learning models.

18. An article of manufacture comprising a non-transitory processor-readable storage medium having stored therein program code of one or more software programs, wherein the program code when executed by at least one processing device causes said at least one processing device to perform the steps of:
collecting operational data corresponding to one or more components of at least one device;
analyzing the operational data against one or more thresholds for component replacement;
generating one or more alerts for at least one user responsive to meeting the one or more thresholds;
receiving one or more communications from the at least one user in response to the one or more alerts; and
automatically dispatching one or more replacement components for the one or more components to the at least one user based at least in part on the received one or more communications;
wherein, in analyzing the operational data against the one or more thresholds, the program code further causes said at least one processing device to perform the steps of:
accessing one or more databases to identify a support entitlement of the at least one user for the at least one device; and
identifying at least one threshold of the one or more thresholds corresponding to the identified support entitlement.

19. The article of manufacture of claim 18 wherein the one or more alerts comprise at least one of a pop-up window and an email requesting address verification of the at least one user.

20. The article of manufacture of claim 19 wherein the program code further causes said at least one processing device to automatically dispatch the one or more replacement components to a verified address.
